(19) United States
(12) Patent Application Publication
(10) Pub. No.: US 2015/0086193 A1
(43) Pub. Date: Mar. 26, 2015

(54) FIBER-NONLINEARITY PRE-COMPENSATION PROCESSING FOR AN OPTICAL TRANSMITTER

(71) Applicant: Alcatel-Lucent USA Inc., Murray Hill, NJ (US)

(72) Inventors: Xiang Liu, Marlboro, NJ (US); Peter J. Winzer, Aberdeen, NJ (US); Chandrasekhar Sethumadhavan, Matawan, NJ (US)

(73) Assignee: ALCATEL-LUCENT USA INC., Murray Hill, NJ (US)

(21) Appl. No.: 14/032,313

(22) Filed: Sep. 20, 2013

(51) Int. Cl. H04B 10/58; H04B 10/2507; H04B 10/079

(52) U.S. Cl. CPC H04B 10/58; H04B 10/0799; H04B 10/2507
USPC 398/28

(57) ABSTRACT

An optical transmitter configured to mitigate the adverse effects of fiber nonlinearity by altering the transmitted constellation symbols based on specific nonlinear characteristics of a fiber-optic link over which the optical transmitter is configured to transmit and on an a priori estimate of the nonlinear component of the optical-signal distortion in that fiber-optic link. In an example embodiment, each constellation symbol is altered by a respective perturbation amount determined using (i) a calculated or measured nonlinear transfer function corresponding to the fiber-optic link and (ii) a set of neighboring constellation symbols that are expected to contribute to the nonlinear distortion of the optical signal carrying the present constellation symbol due to the fiber nonlinearity. In various embodiments, different appropriate perturbation amounts can be selected to approximately pre-compensate nonlinear distortions caused by various nonlinear optical effects, such as four-wave mixing, etc.

### BACKGROUND

1. Field

The present invention relates to optical communication equipment and, more specifically but not exclusively, to fiber-nonlinearity pre-compensation processing for an optical transmitter.

2. Description of the Related Art

This section introduces aspects that may help facilitate a better understanding of the invention(s). Accordingly, the statements of this section are to be read in this light and are not to be understood as admissions about what is in the prior art or what is not in the prior art.

Optical fibers that are typically used in optical transport systems exhibit nonlinear optical effects, e.g., due to the relatively small diameter of the fiber core leading to relatively large local optical intensities over relatively large transmission distances. Mitigating the resulting nonlinear distortions is an important aspect of fiber-optic communication system design, and a variety of optical as well as electronic techniques have been proposed to that effect.

### SUMMARY OF SOME SPECIFIC EMBODIMENTS

Disclosed herein are various embodiments of an optical transmitter configured to mitigate the adverse effects of fiber nonlinearity by altering the transmitted constellation symbols based on specific nonlinear characteristics of a fiber-optic link over which the optical transmitter is configured to transmit and on an a priori estimate of the nonlinear component of the optical-signal distortion in that fiber-optic link. In an example embodiment, each constellation symbol is altered by a respective perturbation amount determined using (i) a calculated or measured nonlinear transfer function corresponding to the fiber-optic link and (ii) a set of neighboring constellation symbols that are expected to contribute to the nonlinear distortion of the optical signal carrying the present constellation symbol due to the fiber nonlinearity. In various embodiments, different appropriate perturbation amounts can be selected to approximately pre-compensate nonlinear distortions caused by various nonlinear optical effects, such as four-wave mixing, etc.

According to one embodiment, provided is an apparatus comprising a front-end circuit configured to: convert one or more electrical digital signals into a modulated optical signal having encoded thereon a first sequence of constellation symbols; and apply the modulated optical signal to a fiber-optic link; and a digital signal processor configured to: for a selected constellation symbol of the first sequence, determine a first respective perturbation amount based on (i) a set of characteristics of a first nonlinear optical process in the fiber-optic link and (ii) a set of other constellation symbols from the first sequence; generate a perturbed constellation symbol by altering the selected constellation symbol using the first respective perturbation amount; and generate said one or more electrical digital signals based on the perturbed constellation symbol.

According to another embodiment, provided is a method of generating a modulated optical signal, the method comprising the step of generating the modulated optical signal, for transmission over a fiber-optic link, by encoding thereon a first sequence of constellation symbols, wherein said encoding comprises: for a selected constellation symbol of the first sequence, determining a first respective perturbation amount based on (i) a set of characteristics of a first nonlinear optical process in the fiber-optic link and (ii) a set of other constellation symbols from the first sequence; generating a perturbed constellation symbol by altering the selected constellation symbol using the first respective perturbation amount; and driving an optical modulator using one or more electrical drive signals generated based on the perturbed constellation symbol.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a block diagram of an optical transmitter according to an embodiment of the disclosure;

FIG. 2 shows a block diagram of a digital signal processor that can be used in the optical transmitter of FIG. 1 according to an embodiment of the disclosure;

FIG. 3 shows a flowchart of a data-processing method that can be used in the processing carried out by the digital signal processor of FIG. 2 according to an embodiment of the disclosure; and

FIGS. 4A-4D graphically show an example of the performance improvements that can be obtained according to an embodiment of the disclosure.

### DETAILED DESCRIPTION

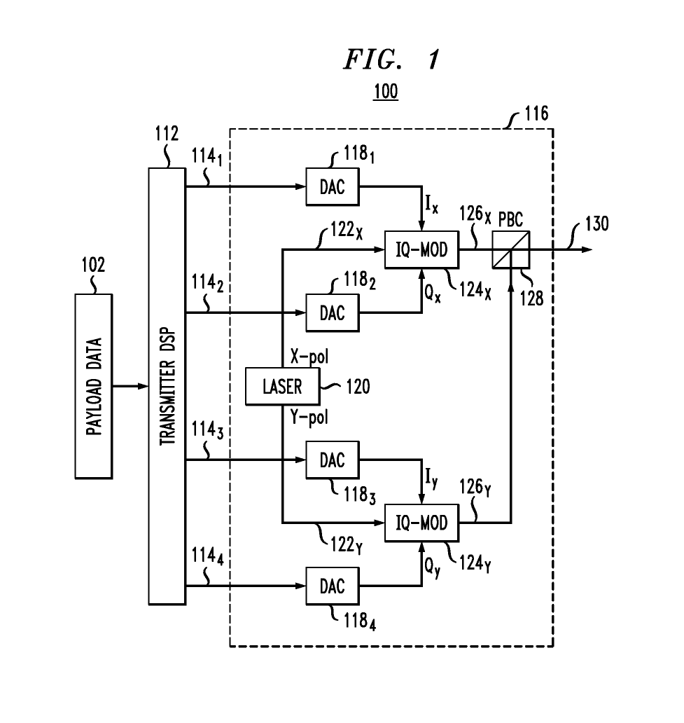

FIG. 1 shows a block diagram of an optical transmitter 100 according to an embodiment of the disclosure. Optical transmitter 100 is configured to (i) modulate light using constellation symbols and (ii) apply a resulting modulated optical output signal 130 to an optical transport link for transmission to a remote optical receiver (not explicitly shown in FIG. 1). Both optical transmitter 100 and the remote optical receiver rely on the same selected constellation (such as a quadrature-amplitude-modulation (QAM) constellation or a quadrature-phase-shift-keying (QPSK) constellation) in the processes of generating signal 130 and decoding the corresponding received optical signal at the remote end of the optical transport link, respectively.

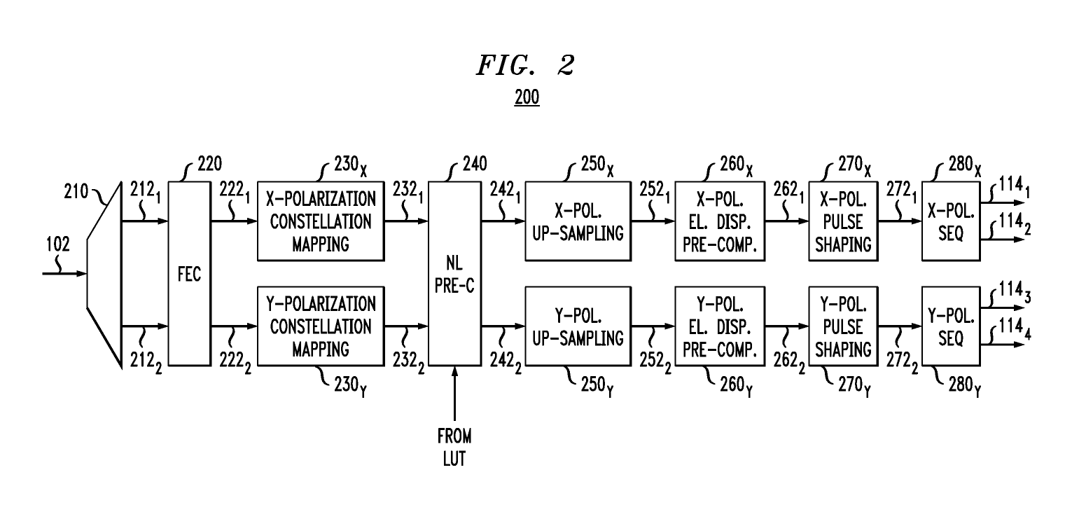

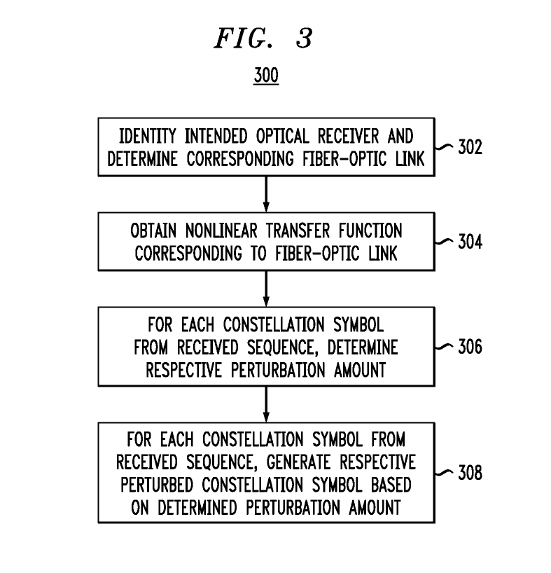

Optical transmitter 100 receives a digital (electrical) input stream 102 of payload data and applies it to a digital signal processor (DSP) 112. DSP 112 processes input stream 102 to generate electrical digital signals 114₁-114₄. Such processing may include, but is not limited to forward-error-correction (FEC) encoding, constellation mapping, fiber-nonlinearity pre-compensation, electronic dispersion pre-compensation, and digital frequency equalization, e.g., implemented as further described below in reference to FIGS. 2-3. In each signaling interval (also referred to as a time slot corresponding to an optical symbol or a symbol period), signals 114₁ and 114₂ carry digital values that represent the in-phase (I) component and quadrature (Q) component, respectively, of the optical waveform corresponding to the constellation point (symbol) intended for transmission using X-polarized light. Signals 114₃ and 114₄ similarly carry digital values that represent the I and Q components, respectively, of the optical waveform corresponding to the constellation point intended for transmission using Y-polarized light, where the Y-polarization is approximately orthogonal to the X-polarization.

An electrical-to-optical (E/O) converter (also sometimes referred to as a front-end circuit) 116 of optical transmitter 100 transforms digital signals 114₁-114₄ into modulated optical output signal 130. More specifically, digital-to-analog converters (DACs) 118₁ and 118₂ transform digital signals 114₁ and 114₂ into an analog form to generate drive signals I_{X} and Q_{X}, respectively. Drive signals I_{X} and Q_{X} are then used, in a conventional manner, to drive an I-Q modulator 124_{X}. Based on drive signals I_{X} and Q_{X}, I-Q modulator 124_{X} modulates an X-polarized beam 122_{X} of light supplied by a laser source 120, thereby generating a modulated optical signal 126_{X}.

DACs 118₃ and 118₄ similarly transform digital signals 114₃ and 114₄ into an analog form to generate drive signals I_{Y} and Q_{Y}, respectively. Based on drive signals I_{Y} and Q_{Y}, an I-Q modulator 124_{Y} modulates a Y-polarized beam 122_{Y} of light supplied by laser source 120, thereby generating a modulated optical signal 126_{Y}.

A polarization beam combiner 128 combines modulated optical signals 126_{X} and 126_{Y} to generate optical output signal 130.

FIG. 2 shows a block diagram of a DSP 200 that can be used as DSP 112 (FIG. 1) according to an embodiment of the disclosure. For illustration purposes, DSP 200 is shown as being configured to receive input data stream 102 and generate digital signals 114₁-114₄ (see FIG. 1). In alternative embodiments, DSP 200 can be configured to receive and/or generate other signals.

DSP 200 includes a de-multiplexer 210 that operates to de-multiplex input data stream 102 to generate data streams 212₁ and 212₂. An FEC (forward-error-correction) encoder 220 then adds redundancy to data streams 212₁ and 212₂, as known in the art, thereby transforming them into FEC-encoded data streams 222₁ and 222₂, respectively.

DSP 200 further includes constellation-mapping modules 230_{X} and 230_{Y} configured to process FEC-encoded data streams 222₁ and 222₂, respectively. More specifically, FEC-encoded data stream 222₁ is applied to constellation-mapping module 230_{X}, where it is converted into a corresponding sequence 232₁ of constellation symbols, wherein each constellation symbol is represented by a complex value. FEC-encoded data stream 222₂ is similarly applied to constellation-mapping module 230_{Y}, where it is converted into a corresponding sequence 232₂ of constellation symbols, in either the time domain or the frequency domain. The constellation used by constellation-mapping modules 230_{X} and 230_{Y} can be, for example, a QAM (Quadrature Amplitude Modulation) constellation or a QPSK (Quadrature Phase Shift Keying) constellation. In some embodiments, constellation-mapping modules 230_{X} and 230_{Y} may be configured to use different respective constellations. In some other embodiments, constellation-mapping modules 230_{X} and 230_{Y} can be replaced by a single constellation-mapping module configured to generate constellation symbols using a multi-dimensional constellation, wherein the signal polarization corresponds to one of the dimensions.

Although example embodiments of DSP 200 are explained herein in reference to two polarization components making up a single-carrier optical signal, one of ordinary skill in the art appreciate that, in some embodiments, e.g., operating over K parallel wavelength channels or over P parallel spatial paths, circuits 220 and 240 may be designed to accept, co-process, and output up to 2K or 2P signals in a manner analogous to that shown in FIG. 2, where K and P are positive integers greater than one. More specifically, the corresponding modulated optical signal, such as signal 130 (FIG. 1), can carry any one or a combination of (i) a polarization-division-multiplexed (PDM) signal; (ii) a space-division-multiplexed (SDM) signal; (iii) a frequency-domain multiplexed (FDM) signal; and (iv) a wavelength-division-multiplexed (WDM) signal.

A nonlinearity pre-compensation (NL pre-C) module 240 operates to transform constellation-symbol sequences 232₁ and 232₂ into perturbed constellation-symbol sequences 242₁ and 242₂, respectively. For example, NL pre-C module 240 can transform each received constellation symbol Eᵢ(t) from constellation-symbol sequence 232ᵢ into a corresponding perturbed constellation symbol Dᵢ(t) for constellation-symbol sequence 242ᵢ in accordance with Eq. (1):

Dᵢ(t)=Eᵢ(t)−δEᵢ(t) (1)

where i=1, 2; t is a discrete-time index, e.g., realized in the form of a symbol-period counter; each of Dᵢ(t), Eᵢ(t), and δEᵢ(t) is a complex value; and δEᵢ(t) is the perturbation amount that can be determined, e.g., as further described below in reference to FIG. 3. In this particular embodiment, index i denotes polarization, e.g., X-polarization for i=1, and Y-polarization for i=2. In an alternative embodiment, index i may denote a spatial path from a set of P possible spatial paths, i.e., index i can be 1, 2, . . . P. In another alternative embodiment, index i may denote an optical carrier from a set of K optical carriers, i.e., index i can be 1, 2, . . . K.

In an example embodiment, δEᵢ(t) has one or more of the following characteristics:
(1) δEᵢ(t) is a function of time, as the notation implies;
(2) perturbation amounts δEᵢ(t) (where i=1, 2) depend on the nonlinear characteristics of the concrete fiber-optic link between the host optical transmitter, e.g., optical transmitter 100 (FIG. 1), and the intended remote optical receiver, e.g., the intended receiver of optical output signal 130 (FIG. 1). In one embodiment, each of perturbation amounts δEᵢ(t) can be based on a respective estimate of the nonlinear component of the optical-signal distortion in the fiber-optic link and be selected to cause a reduction of that component at the remote optical receiver, accompanied by a concomitant reduction in the BER;
(3) different occurrences of the same constellation symbol from constellation-symbol sequence 232ᵢ may be perturbed in NL pre-C module 240 by different respective perturbation amounts δEᵢ(t);
(4) perturbation amount δE₁(t) depends on constellation symbol E₁(t);
(5) perturbation amount δE₂(t) depends on constellation symbol E₂(t);
(6) perturbation amount δEᵢ(t) (where i=1, 2) depends on one or more constellations symbols that precede constellation symbol Eᵢ(t) in constellation-symbol sequence 232ᵢ;
(7) perturbation amount δEᵢ(t) (where i=1, 2) depends on one or more constellations symbols that follow constellation symbol Eᵢ(t) in constellation-symbol sequence 232ᵢ;
(8) perturbation amount δE₁(t) depends on constellation symbol E₂(t);
(9) perturbation amount δE₂(t) depends on constellation symbol E₁(t);
(10) perturbation amount δE₁(t) depends on one or more constellations symbols that precede constellation symbol E₂(t) in constellation-symbol sequence 232₂;
(11) perturbation amount δE₁(t) depends on one or more constellations symbols that follow constellation symbol E₂(t) in constellation-symbol sequence 232₂;
(12) perturbation amount δE₂(t) depends on one or more constellations symbols that precede constellation symbol E₁(t) in constellation-symbol sequence 232₁; and
(13) perturbation amount δE₂(t) depends on one or more constellations symbols that follow constellation symbol E₁(t) in constellation-symbol sequence 232₁.
   In various embodiments, NL pre-C module 240 can be configured to generate perturbation amounts δEᵢ(t) to approximately pre-compensate nonlinear distortions caused by any pertinent or selected subset of the following set of nonlinear optical effects: (i) self-phase modulation, SPM; (ii) cross-phase modulation, XPM; (iii) four-wave mixing or four-photon mixing, FWM; (iv) cross-polarization modulation, XPolM; and (v) cross-mode modulation, XMM (present in some SDM systems).

In some embodiments, DSP 200 may include optional up-sampling modules 250_{X} and 250_{Y}. More specifically, up-sampling module 250_{X} is configured to up-sample perturbed constellation-symbol sequence 242₁ to generate an up-sampled (complex-valued) digital signal 252₁. Up-sampling module 250_{Y} is similarly configured to up-sample perturbed constellation-symbol sequence 242₂ to generate an up-sampled (complex-valued) digital signal 252₂.

As used herein, the term “up-sampling” refers to a process of increasing the rate of a signal by an up-sampling factor (commonly denoted by L), which is typically an integer or a rational fraction greater than one. The up-sampling factor effectively multiplies the sampling rate or, equivalently, shortens the sampling period.

Digital signals 252₁ and 252₂ are applied to electronic dispersion pre-compensation modules 260_{X} and 260_{Y}, respectively. More specifically, electronic dispersion pre-compensation module 260_{X} is configured to apply dispersion pre-compensation to digital signal 252₁ to generate a (complex-valued) digital signal 262₁. Electronic dispersion pre-compensation module 260_{Y} is similarly configured to apply dispersion pre-compensation to digital signal 252₂ to generate a (complex-valued) digital signal 262₂.

The term “dispersion compensation” is sometimes used to refer to a process of substantially canceling the chromatic dispersion introduced by an optical element or a combination of optical elements. Alternatively, the term “dispersion compensation” is used in a more general sense of dispersion management, e.g., in reference to the built-in capability to at least partially control the overall chromatic dispersion in the fiber-optic link. The purposes of dispersion compensation include, but are not limited to reducing the effects of excessive temporal broadening of short optical pulses caused by chromatic dispersion and mitigating detrimental distortion of waveforms and/or signal envelopes in the fiber-optic link caused by fiber nonlinearity.

The amounts of dispersion pre-compensation applied by dispersion pre-compensation modules 260_{X} and 260_{Y} are determined based on the dispersion characteristics of the concrete fiber-optic link between the host optical transmitter, e.g., optical transmitter 100 (FIG. 1), and the intended remote optical receiver, e.g., the intended receiver of optical output signal 130 (FIG. 1).

For example, in one embodiment, the amount of dispersion pre-compensation can be about −Dₗᵢₙₖ/2, where Dₗᵢₙₖ is the total accumulated dispersion in the fiber-optic transmission link. In effect, this amount of dispersion pre-compensation tends to make the dispersion map symmetric, and halves the absolute value of the maximum accumulated dispersion, which in turn halves the maximum overlap of the modulated signal symbols. The reduction of the maximum overlap of the modulated signal symbols leads to a concomitant reduction of the number of distinct four-photon-mixing interactions, thereby enabling a reduction of the complexity of the signal processing implemented in NL pre-C module 240.

Some embodiments of DSP 200 in general and dispersion pre-compensation modules 260_{X} and 260_{Y} in particular may benefit from the use of certain embodiments of the dispersion pre-compensation technique disclosed in U.S. patent application Ser. No. ______, filed on the same date as the present application, by Xiang Liu, Chandra Sethumadhavan, and Peter Winzer, attorney docket reference 814098-US-NP, entitled “DISPERSION MANAGEMENT FOR INHOMOGENEOUS FIBER-OPTIC LINKS,” which is incorporated herein by reference in its entirety.

Digital signals 262₁ and 262₂ are applied to pulse-shaping filters 270_{X} and 270_{Y}, respectively. More specifically, pulse-shaping filter 270_{X} is configured to filter digital signal 262₁ to generate a (complex-valued) filtered digital signal 272₁. Pulse-shaping filter 270_{Y} is similarly configured to filter digital signal 262₂ to generate a (complex-valued) filtered digital signal 272₂.

As used herein, the term “pulse shaping” refers to a process of changing the waveform or envelope of a transmitted optical pulse. An example purpose of pulse shaping is to make the transmitted optical signal better suited for transmission over the concrete fiber-optic link, e.g., by limiting the effective bandwidth of the signal. Examples of pulse-shaping filters that can be used as pulse-shaping filters 270_{X} and 270_{Y} in various embodiments of DSP 200 include, but are not limited to (i) a square-root raised cosine filter, (ii) a raised-cosine filter, (iii) a boxcar filter, (iv) a sinc-function filter, and (v) a Gaussian filter.

Digital signals 272₁ and 272₂ are applied to spectral-equalization (SEQ) filters 280_{X} and 280_{Y}, respectively. More specifically, SEQ filter 280_{X} is configured to filter digital signal 272₁ to generate digital signals 114₁ and 114₂ (also see, FIG. 1). SEQ filter 280_{Y} is similarly configured to filter digital signal 272₂ to generate digital signals 114₃ and 114₄ (also see, FIG. 1). An example SEQ technique that can be used in SEQ modules 280_{X} and 280_{Y} is disclosed, e.g., in U.S. patent application Ser. No. 13/556,635, filed on Jul. 24, 2012, which is incorporated herein by reference in its entirety.

FIG. 3 shows a flowchart of a data-processing method 300 that can be used in NL pre-C module 240 (FIG. 2) according to an embodiment of the disclosure. For clarity of description, method 300 is illustratively described in reference to a single selected non-linear optical effect, which happens to be four-wave mixing. Based on the provided description, one of ordinary skill in the art will readily understand how to modify method 300 to be applicable to a different single non-linear optical effect, e.g., from the above-mentioned set of nonlinear optical effects (see the description of NL pre-C module 240 above), or to a combination of several non-linear optical effects.

The processing of method 300 begins at step 302, whereat the identity/location of the intended optical receiver and the type of the corresponding fiber-optic link is specified or determined. This information can be derived, e.g., from the data-packet headers corresponding to input data stream 102 (FIG. 1) and the map of the optical network, or conveyed to the optical transmitter through a database having stored therein information about the optical circuit connections and the physical fiber infrastructure.

At step 304, a nonlinear transfer function corresponding to the fiber-optic link determined at step 302 is obtained. In an example embodiment, said nonlinear transfer function is a matrix, wherein each matrix element can be related to or derived from the relevant nonlinear optical susceptibilities that characterize the optical fiber used in the fiber-optic link. In some embodiments, the nonlinear transfer function can be a tensor.

In some embodiments, the nonlinear transfer functions for the various pertinent fiber-optic links in the network can be computed or measured prior to the optical transmitter's deployment and then loaded into the optical transmitter, e.g., in the form of a look-up table (LUT). Then, in operation, the optical transmitter can execute step 304 by reading the appropriate nonlinear transfer function from the LUT, e.g., as indicated in FIG. 2.

In some embodiments, the nonlinear transfer function can be computed by the DSP of the host optical transmitter, e.g., based on the link characteristics (such as the optical loss and dispersion in each of the fiber spans of the fiber-optic link) and the J-function model, e.g., as disclosed in X. Wei, “Power-Weighted Dispersion Distribution Function for Characterizing Nonlinear Properties of Long-Haul Optical Transmission Links,” Optics Letters, v. 31, pp. 2544-2546 (2006), which is incorporated herein by reference in its entirety. In some embodiments, the aforementioned link characteristics include the power evolution of the fiber link and/or the power-weighted dispersion distribution function.

At step 306, for each polarization-division-multiplexed (PDM) constellation symbol [E₁(t), E₂(t)] provided to NL pre-C module 240 via sequences 232₁ and 232₂ at time t, NL pre-C module 240 determines perturbation amounts δE₁(t) and δE₂(t) based on (i) the nonlinear transfer function obtained at step 304, (ii) PDM constellation symbol [E₁(t), E₂(t)], and (iii) a set of PDM constellation symbols [E₁(t+n), E₂(t+n)] provided to NL pre-C module 240 via sequences 232₁ and 232₂ at various times t+n, where n can be positive and/or negative, and n≠0. As explained above, in some embodiments, more than two coupled dimensions, such as K optical carriers or P parallel spatial paths, may be used. The corresponding modification of step 306 can readily be accomplished, e.g., by including therein the calculations corresponding to the values of index i from 1 to 2K or from 1 to 2P, respectively (see Eq. (1)).

In some embodiments, NL pre-C module 240 can be configured to calculate perturbation amounts δE₁(t) and δE₂(t), e.g., using Eqs. (2a)-(2b):

$$\begin{matrix}δ {E}_{1} ( t ) = {\sum }_{m = - M}^{M} {\sum }_{n = - N}^{N} h ( m , n ) [ {E}_{1} ( t + m ) {E}_{1} ( t + n ) {E}_{1}^{*} ( t + m + n ) + {E}_{2} ( t + m ) {E}_{1} ( t + n ) {E}_{2}^{*} ( t + n + m ) ] & ( 2 a ) \\ δ {E}_{2} ( t ) = {\sum }_{m = - M}^{M} {\sum }_{n = - N}^{N} h ( m , n ) [ {E}_{2} ( t + m ) {E}_{2} ( t + n ) {E}_{2}^{*} ( t + m + n ) + {E}_{1} ( t + m ) {E}_{2} ( t + n ) {E}_{1}^{*} ( t + n + m ) ] & ( 2 b )\end{matrix}$$

where N and M are positive integers greater than one; h(m,n) is the (m,n)-th element of the nonlinear transfer function obtained at step 304; and the “*” sign denotes the complex conjugate. In some embodiments, M=N.

Note that the respective constellation-symbol construct that follows h(m,n) in each of Eqs. (2a)-(2b) corresponds to and reflects the physical mechanism of the electromagnetic-wave interaction in the fiber-optic link governed by the selected nonlinear optical process, which, in this particular case, is a four-photon-mixing or four-wave-mixing process. As already indicated above, appropriate constellation-symbol constructs can readily be created for any selected nonlinear optical process, e.g., based on the equations that govern the corresponding nonlinear electromagnetic-wave interaction in the fiber-optic link.

In some embodiments, NL pre-C module 240 can be configured to act on frequency-domain symbol sequences, rather than on time-domain symbol sequences. In one embodiment, the frequency-domain symbols sequences may be multiplexed, via orthogonal frequency-division multiplexing (OFDM), in a respective constellation-mapping module 230. NL pre-C module 240 may then transform each received frequency-domain constellation symbol Eᵢ(f) from constellation-symbol sequence 232ᵢ into a corresponding perturbed constellation symbol Dᵢ(f) for constellation-symbol sequence 242ᵢ in accordance with Eq. (3):

Dᵢ(f)=Eᵢ(f)−δEᵢ(f) (3)

where i=1, 2; f is a discrete frequency index, e.g., realized in the form of an OFDM subcarrier counter; each of Dᵢ(f), Eᵢ(f), and δEᵢ(f) is a complex value; and δEᵢ(f) is the perturbation amount that can be determined, e.g., as further described below in reference to FIG. 3. In this particular embodiment, index i denotes polarization, e.g., X-polarization for i=1, and Y-polarization for i=2. In an alternative embodiment, index i may denote a spatial path from a set of P possible spatial paths, i.e., index i can be 1, 2, . . . P. In another alternative embodiment, index i may denote an optical carrier from a set of K optical carriers, i.e., index i can be 1, 2, . . . K.

In some embodiments, NL pre-C module 240 may be configured to calculate perturbation amounts δE₁(f) and δE₂(f), e.g., using Eqs. (4a)-(4b):

$$\begin{matrix}δ {E}_{1} ( f ) = {\sum }_{m = - M}^{M} {\sum }_{n = - N}^{N} η ( m , n ) [ {E}_{1} ( f + m ) {E}_{1} ( f + n ) {E}_{1}^{*} ( f + m + n ) + {E}_{2} ( f + m ) {E}_{1} ( f + n ) {E}_{2}^{*} ( f + n + m ) ] & ( 4 a ) \\ δ {E}_{2} ( f ) = {\sum }_{m = - M}^{M} {\sum }_{n = - N}^{N} η ( m , n ) [ {E}_{2} ( f + m ) {E}_{2} ( f + n ) {E}_{2}^{*} ( f + m + n ) + {E}_{1} ( f + m ) {E}_{2} ( f + n ) {E}_{1}^{*} ( f + n + m ) ] & ( 4 b )\end{matrix}$$

where N and M are positive integers greater than one; η(m,n) is the (m,n)-th element of the frequency-domain nonlinear transfer function obtained at step 304; and the “*” sign denotes the complex conjugate. In some embodiments, M=N.

In some embodiments, the frequency-domain nonlinear transfer function can be readily computed by the DSP of the host optical transmitter, e.g., based on the power-weighted dispersion distribution and the J-function model.

In an alternative embodiment, to take into account multiple nonlinear optical processes, the perturbation amounts δE₁(t) and δE₂(t) can be replaced by cumulative perturbation amounts calculated as sums of partial perturbation amounts, each corresponding to the respective single nonlinear optical process and calculated using an equation that is generally analogous to Eq. (2a) or (2b) but reflects that nonlinear optical process. In that sense, Eqs. (2a)-(2b) give partial perturbation amounts corresponding to four-wave mixing.

In some embodiments, the computation of perturbation amounts δE₁(t) and δE₂(t) performed at step 306 can be simplified, e.g., by using logic operations instead of complex multiplications. This approach can be implemented, e.g., for a PDM-BPSK or PDM-QPSK constellation, in which the respective real and imaginary parts of the various constellation symbols can be represented using the values of +1 and −1. In the case of a relatively large constellation, such as a PDM-16QAM constellation, the processing performed at step 306 can be simplified, e.g., by treating the constellation as a sum of several PDM-QPSK constellations scaled by different respective amplitudes. In the cases of other modulation formats carrying other numbers of bits per symbol, set-partitioned PDM-16QAM can be used, e.g., as disclosed in J. Renaudier et al., “Comparison of Set-Partitioned Two-Polarization 16QAM Formats with PDM-QPSK and PDM-8QAM for Optical Transmission Systems with Error-Correction Coding,” Proceedings of ECOC' 12, We.1.C.5 (2012), which is incorporated herein by reference in its entirety. For example, 32-ary set-partitioned 16QAM (32SP-16QAM), 64-ary set-partitioned 16QAM (64SP-16QAM), and 128-ary set-partitioned 16QAM (128SP-16QAM) can be used to carry five, six, and seven bits per symbol, respectively. As all these SP-16QAM formats have constellation points exactly corresponding to the 16-QAM constellation, the multiplications between the symbol fields shown in Eqs. (2a) and (2b) can be realized by relatively simple logic operations, which can reduce the digital-signal processing complexity of NL pre-C module 240.

In some embodiments, set-partitioned 64QAM signals can be used to carry more than eight bits per symbol.

At step 308, NL pre-C module 240 calculates perturbed constellation symbols D₁(t) and D₂(t) for constellation-symbol sequences 242₁ and 242₂, respectively, in accordance with Eq. (1) and using the perturbation amounts δE₁(t) and δE₂(t) determined at step 306.

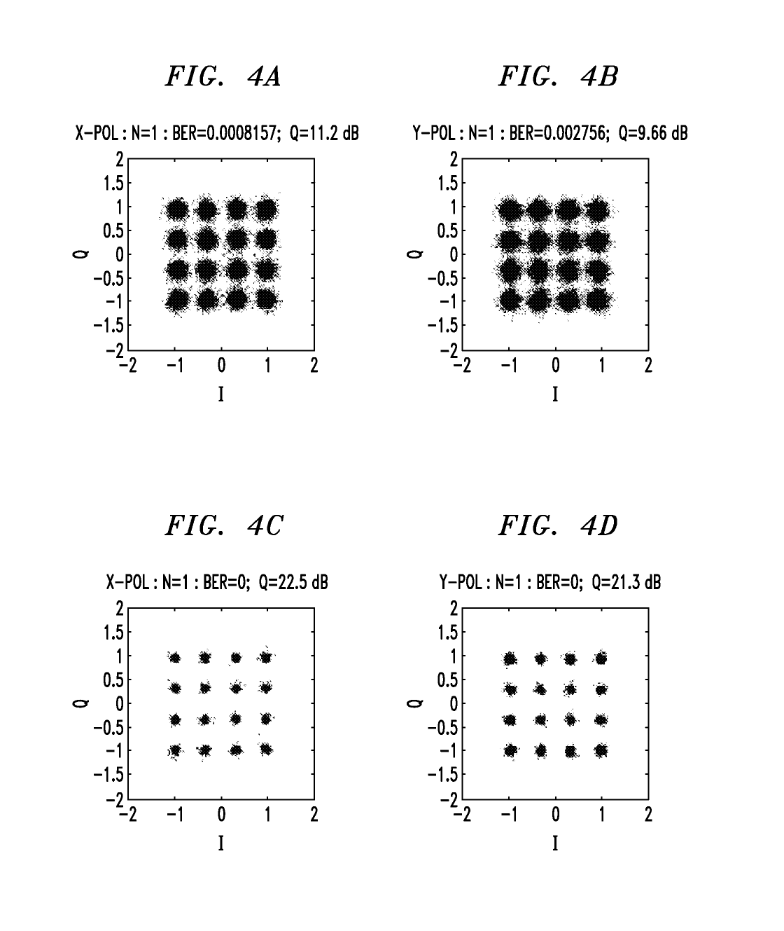

FIGS. 4A-4D graphically show an example of the expected performance improvements that can be obtained according to an embodiment of the disclosure.

More specifically, FIGS. 4A-4B graphically show the received-signal statistics at the intended optical receiver when modulated optical output signal 130 (see FIG. 1) is generated using optical transmitter 100 (FIG. 1) equipped with DSP 200 (see FIG. 2), wherein the processing implemented in NL pre-C module 240 is turned OFF. The intended optical receiver is coupled to optical transmitter 100 (FIG. 1) via a span of standard single-mode fiber that is about 1600 km long. The data rate is 256 Gb/s; and the operative constellation is a PDM-16QAM constellation. The data of FIG. 4A correspond to the X-polarization; and the data of FIG. 4B correspond to the Y-polarization.

FIGS. 4C-4D similarly show the signal statistics at the intended optical receiver when modulated optical output signal 130 (see FIG. 1) is generated using optical transmitter 100 (FIG. 1) equipped with DSP 200 (FIG. 2), wherein the processing implemented in NL pre-C module 240 in accordance with method 300 (FIG. 3) is turned ON. Other transmission conditions are the same as in the case of FIGS. 4A-4B. The data of FIG. 4C correspond to the X-polarization; and the data of FIG. 4D correspond to the Y-polarization.

Comparison of the data shown in FIGS. 4C-4D with the data shown in FIGS. 4A-4B indicates a significant improvement in the BER due to the processing implemented in NL pre-C module 240. Qualitatively, the improvement manifests itself through the tighter clustering of the received optical symbols around the locations of the constellation points of the operative PDM-16QAM constellation. Quantitative estimates indicate that a gain of as much as about 10 dB in the variance of the Q²-factor can be obtained in this manner.

According to an embodiment disclosed above in reference to FIGS. 1-4, provided is an apparatus comprising a front-end circuit (e.g., 116, FIG. 1) and a digital signal processor (e.g., 112, FIG. 1, or 200, FIG. 2). The front-end circuit is configured to: convert one or more electrical digital signals (e.g., 114, FIG. 1) into a modulated optical signal (e.g., 130, FIG. 1) having encoded thereon a first sequence (e.g., 232₁, FIG. 2) of constellation symbols; and apply the modulated optical signal to a fiber-optic link. The digital signal processor is configured to: for a selected constellation symbol (e.g., E₁(t)) of the first sequence, determine a first respective perturbation amount (e.g., δE₁(t)) based on (i) a set of characteristics of a first nonlinear optical process (e.g., FWM) in the fiber-optic link and (ii) a set of other constellation symbols from the first sequence; generate a perturbed constellation symbol (e.g., D₁(t)) by altering the selected constellation symbol using the first respective perturbation amount; and generate said one or more electrical digital signals based on the perturbed constellation symbol.

In some embodiments of the above apparatus, the set of the other constellation symbols includes at least one other constellation symbol (e.g., E₁(t−M), Eq. (2a)) that precedes the selected constellation symbol in the first sequence.

In some embodiments of any of the above apparatus, the set of the other constellation symbols further includes at least one other constellation symbol (e.g., E₁(t+M), Eq. (2a)) that follows the selected constellation symbol in the first sequence.

In some embodiments of any of the above apparatus, the selected constellation symbol is one of the following: a PDM-BPSK symbol; a PDM-QPSK symbol; a PDM-16QAM symbol; a set-partitioned 16QAM symbol; a set-partitioned 64QAM symbol; and an OFDM subcarrier symbol.

In some embodiments of any of the above apparatus, the digital signal processor comprises a logic circuit configured to generate the perturbed constellation.

In some embodiments of any of the above apparatus, the modulated optical signal is one or a combination of two or more of the following: a polarization-division-multiplexed (PDM) signal; a space-division-multiplexed (SDM) signal; a frequency-domain multiplexed (FDM) signal; and a wavelength-division-multiplexed (WDM) signal.

In some embodiments of any of the above apparatus, the digital signal processor is further configured to apply dispersion pre-compensation to cause a reduction in a maximum symbol overlap in the fiber-optic link compared to a maximum symbol overlap in the fiber-optic link without said dispersion pre-compensation.

In some embodiments of any of the above apparatus, the digital signal processor is further configured to apply dispersion pre-compensation in the amount of approximately (e.g., within 20% of) −Dₗᵢₙₖ/2, where Dₗᵢₙₖ is a total dispersion imposed by the fiber-optic link.

In some embodiments of any of the above apparatus, the digital signal processor is further configured to determine the first respective perturbation amount based on a set of characteristics of the fiber-optic link.

In some embodiments of any of the above apparatus, said set of characteristics of the fiber-optic link includes power evolution of the modulated optical signal in the fiber-optic link.

In some embodiments of any of the above apparatus, said set of characteristics of the fiber-optic link includes a power-weighted dispersion distribution function.

In some embodiments of any of the above apparatus, the front-end circuit is further configured to convert the one or more electrical digital signals into the modulated optical signal such that the modulated optical signal further has encoded thereon a second sequence (e.g., 232₂, FIG. 2) of constellation symbols.

In some embodiments of any of the above apparatus, the first sequence of constellation symbols is encoded onto a first (e.g., X) polarization of the modulated optical signal; and the second sequence of constellation symbols is encoded onto a second (e.g., Y) polarization of the modulated optical signal, said second polarization being approximately (e.g., to within 10 degrees) orthogonal to the first polarization.

In some embodiments of any of the above apparatus, the first sequence of constellation symbols is encoded onto a first spatial mode of the modulated optical signal; and the second sequence of constellation symbols is encoded onto a second spatial mode of the modulated optical signal, said second spatial mode being different (e.g., described by an orthogonal function or being a different Eigenmode of the multimode fiber) from the first spatial mode.

In some embodiments of any of the above apparatus, the digital signal processor is further configured to determine the first respective perturbation amount based on a set of constellation symbols from the second sequence.

In some embodiments of any of the above apparatus, the set of constellation symbols from the second sequence includes a constellation symbol (e.g., E₂(t)) that is concurrent with the selected constellation symbol.

In some embodiments of any of the above apparatus, the set of constellation symbols from the second sequence includes at least one constellation symbol (e.g., E₂(t−M), Eq. (2a)) that precedes a symbol period in which the selected constellation symbol appears in the first sequence.

In some embodiments of any of the above apparatus, the set of constellation symbols from the second sequence includes at least one constellation symbol (e.g., E₂(t+N+M), Eq. (2a)) that follows a symbol period in which the selected constellation symbol appears in the first sequence.

In some embodiments of any of the above apparatus, the digital signal processor is further configured to: for a selected constellation symbol (e.g., E₂(t)) of the second sequence, determine a second respective perturbation amount (e.g., δE₂(t)) based on (i) the characteristics of the first nonlinear optical process in the fiber-optic link and (ii) a set of other constellation symbols from the second sequence; generate another perturbed constellation symbol (e.g., D₂(t)) by altering the selected constellation symbol of the second sequence using the second respective perturbation amount; and generate said one or more electrical digital signals based also on said other perturbed constellation symbol.

In some embodiments of any of the above apparatus, the set of said other constellation symbols from the second sequence includes at least one other constellation symbol (e.g., E₂(t−M), Eq. (2b)) that precedes the selected constellation symbol of the second sequence in the second sequence.

In some embodiments of any of the above apparatus, the set of said other constellation symbols from the second sequence includes at least one other constellation symbol (e.g., E₂(t+M), Eq. (2b)) that follows the selected constellation symbol of the second sequence in the second sequence.

In some embodiments of any of the above apparatus, the digital signal processor is further configured to determine the second respective perturbation amount based on a set of constellation symbols from the first sequence.

In some embodiments of any of the above apparatus, the set of constellation symbols from the first sequence includes a constellation symbol (e.g., E₁(t)) that is concurrent with the selected constellation symbol of the second sequence.

In some embodiments of any of the above apparatus, the set of constellation symbols from the first sequence includes at least one constellation symbol (e.g., E₁(t−M), Eq. (2b)) that precedes a symbol period in which the selected constellation symbol of the second sequence appears in the second sequence.

In some embodiments of any of the above apparatus, the set of constellation symbols from the first sequence includes at least one constellation symbol (e.g., E₁(t+N+M), Eq. (2b)) that follows a symbol period in which the selected constellation symbol of the second sequence appears in the second sequence.

In some embodiments of any of the above apparatus, the digital signal processor is further configured to: for the selected constellation symbol (e.g., E₁(t)) of the first sequence, determine a second respective perturbation amount based on (i) a set of characteristics of a second nonlinear optical process (e.g., FWM, SPM, XPM, XPolM, or XMM) in the fiber-optic link and (ii) a respective set of constellation symbols from the first sequence; and generate the perturbed constellation symbol (e.g., D₁(t)) by altering the selected constellation symbol using both the first respective perturbation amount and the second respective perturbation amount.

In some embodiments of any of the above apparatus, the apparatus further comprises at least a portion of the fiber-optic link.

In some embodiments of any of the above apparatus, said portion of the fiber-optic link comprises a multimode fiber or a single-mode fiber.

In some embodiments of any of the above apparatus, the digital signal processor is configured to: generate a respective perturbed constellation symbol for each constellation symbol of the first sequence, thereby generating a corresponding sequence (e.g., 242₁, FIG. 2) of perturbed constellation symbols; and generate said one or more electrical digital signals based on said corresponding sequence of the perturbed constellation symbols.

In some embodiments of any of the above apparatus, the digital signal processor comprises a dispersion pre-compensation module (e.g., 260, FIG. 2) configured to apply dispersion pre-compensation processing to the corresponding sequence of the perturbed constellation symbols to generate a complex-valued digital signal (e.g., 262₁, FIG. 2); and the digital signal processor is further configured to generate said one or more electrical digital signals based on said complex-valued digital signal.

In some embodiments of any of the above apparatus, the set of characteristics of the first nonlinear optical process comprises a nonlinear transfer function (e.g., h(m,n), Eqs. (2a)-(2b)); and the digital signal processor is configured to read said nonlinear transfer function from a look-up table having stored therein a plurality of pre-computed nonlinear transfer functions, each corresponding to a different respective fiber-optic link in a fiber-optic network configured to transport the modulated optical signal.

According to another embodiment disclosed above in reference to FIGS. 1-4, provided is a method of generating a modulated optical signal (e.g., 130, FIG. 1), the method comprising the step of generating the modulated optical signal, for transmission over a fiber-optic link, by encoding thereon a first sequence (e.g., 232₁, FIG. 2) of constellation symbols, wherein said encoding comprises: for a selected constellation symbol (e.g., E₁(t)) of the first sequence, determining a first respective perturbation amount (e.g., δE₁(t)) based on (i) a set of characteristics of a first nonlinear optical process (e.g., FWM) in the fiber-optic link and (ii) a set of other constellation symbols from the first sequence; generating a perturbed constellation symbol (e.g., Dᵢ(t)) by altering the selected constellation symbol using the first respective perturbation amount; and driving an optical modulator (e.g., 124, FIG. 1) using one or more electrical drive signals generated based on the perturbed constellation symbol.

While this invention has been described with reference to illustrative embodiments, this description is not intended to be construed in a limiting sense. Various modifications of the described embodiments, as well as other embodiments of the invention, which are apparent to persons skilled in the art to which the invention pertains are deemed to lie within the principle and scope of the invention as expressed in the following claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels (if any) in the claims is intended to identify one or more possible embodiments of the claimed subject matter in order to facilitate the interpretation of the claims. Such use is not to be construed as necessarily limiting the scope of those claims to the embodiments indicated by the reference labels.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The description and drawings merely illustrate the principles of the invention(s). It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An apparatus comprising:
a front-end circuit configured to:
convert one or more electrical digital signals into a modulated optical signal having encoded thereon a first sequence of constellation symbols; and
apply the modulated optical signal to a fiber-optic link; and
a digital signal processor configured to:
for a selected constellation symbol of the first sequence,
determine a first respective perturbation amount based on (i) a set of characteristics of a first nonlinear optical process in the fiber-optic link and (ii) a set of other constellation symbols from the first sequence;
generate a perturbed constellation symbol by altering the selected constellation symbol using the first respective perturbation amount; and
generate said one or more electrical digital signals based on the perturbed constellation symbol.

2. The apparatus of claim 1, wherein the set of said other constellation symbols includes one or both of:
at least one other constellation symbol that precedes the selected constellation symbol in the first sequence; and
at least one other constellation symbol that follows the selected constellation symbol in the first sequence.

3. The apparatus of claim 1, wherein the selected constellation symbol is one of the following:
a PDM-BPSK symbol;
a PDM-QPSK symbol;
a PDM-16QAM symbol;
a set-partitioned 16QAM symbol;
a set-partitioned 64QAM symbol; and
an OFDM subcarrier symbol.

4. The apparatus of claim 1, wherein the digital signal processor is further configured to determine the first respective perturbation amount based on a selected set of characteristics of the fiber-optic link.

5. The apparatus of claim 1, wherein said selected set of characteristics of the fiber-optic link includes one or both of:
power evolution of the modulated optical signal in the fiber-optic link; and
a power-weighted dispersion distribution function.

6. The apparatus of claim 1, wherein the front-end circuit is further configured to convert the one or more electrical digital signals into the modulated optical signal such that the modulated optical signal also has encoded thereon a second sequence of constellation symbols.

7. The apparatus of claim 6, wherein:
the first sequence of constellation symbols is encoded onto a first polarization of the modulated optical signal; and
the second sequence of constellation symbols is encoded onto a second polarization of the modulated optical signal, said second polarization being approximately orthogonal to the first polarization.

8. The apparatus of claim 6, wherein:
the first sequence of constellation symbols is encoded onto a first spatial mode of the modulated optical signal; and
the second sequence of constellation symbols is encoded onto a second spatial mode of the modulated optical signal, said second spatial mode being different from the first spatial mode.

9. The apparatus of claim 6, wherein the digital signal processor is further configured to determine the first respective perturbation amount based on a set of constellation symbols from the second sequence.

10. The apparatus of claim 9, wherein the set of constellation symbols from the second sequence includes one or more of the following:
a constellation symbol that is concurrent with the selected constellation symbol;
at least one constellation symbol that precedes a symbol period in which the selected constellation symbol appears in the first sequence; and
at least one constellation symbol that follows a symbol period in which the selected constellation symbol appears in the first sequence.

11. The apparatus of claim 4, wherein the digital signal processor is further configured to:
for a selected constellation symbol of the second sequence,
determine a second respective perturbation amount based on (i) the characteristics of the first nonlinear optical process in the fiber-optic link and (ii) a set of other constellation symbols from the second sequence;
generate another perturbed constellation symbol by altering the selected constellation symbol of the second sequence using the second respective perturbation amount; and
generate said one or more electrical digital signals also based on said another perturbed constellation symbol.

12. The apparatus of claim 11, wherein the set of said other constellation symbols from the second sequence includes at least one other constellation symbol that precedes the selected constellation symbol of the second sequence in the second sequence.

13. The apparatus of claim 11, wherein the set of said other constellation symbols from the second sequence includes at least one other constellation symbol that follows the selected constellation symbol of the second sequence in the second sequence.

14. The apparatus of claim 11, wherein the digital signal processor is further configured to determine the second respective perturbation amount based on a set of constellation symbols from the first sequence.

15. The apparatus of claim 14, wherein the set of constellation symbols from the first sequence includes one or more of the following:
a constellation symbol that is concurrent with the selected constellation symbol of the second sequence;
at least one constellation symbol that precedes a symbol period in which the selected constellation symbol of the second sequence appears in the second sequence; and
at least one constellation symbol that follows a symbol period in which the selected constellation symbol of the second sequence appears in the second sequence.

16. The apparatus of claim 1, wherein the digital signal processor is further configured to:
for the selected constellation symbol of the first sequence,
determine a second respective perturbation amount based on (i) a set of characteristics of a second nonlinear optical process in the fiber-optic link, said second nonlinear optical process being different from the nonlinear optical process, and (ii) a respective set of constellation symbols from the first sequence; and
generate the perturbed constellation symbol by altering the selected constellation symbol using both the first respective perturbation amount and the second respective perturbation amount.

17. The apparatus of claim 1, wherein the digital signal processor is configured to:
generate a respective perturbed constellation symbol for each constellation symbol of the first sequence, thereby generating a corresponding sequence of perturbed constellation symbols; and
generate said one or more electrical digital signals based on said corresponding sequence of the perturbed constellation symbols.

18. The apparatus of claim 17,
wherein the digital signal processor comprises a dispersion pre-compensation module configured to apply dispersion pre-compensation processing to the corresponding sequence of the perturbed constellation symbols to generate a complex-valued digital signal; and
wherein the digital signal processor is further configured to generate said one or more electrical digital signals based on said complex-valued digital signal.

19. The apparatus of claim 1,
wherein the set of characteristics of the first nonlinear optical process comprises a nonlinear transfer function; and
wherein the digital signal processor is configured to read said nonlinear transfer function from a look-up table having stored therein a plurality of pre-computed nonlinear transfer functions, each corresponding to a different respective fiber-optic link in a fiber-optic network configured to transport the modulated optical signal.

20. A method of generating a modulated optical signal, the method comprising:
generating the modulated optical signal, for transmission over a fiber-optic link, by encoding thereon a first sequence of constellation symbols, wherein said encoding comprises:
for a selected constellation symbol of the first sequence,
determining a first respective perturbation amount based on (i) a set of characteristics of a first nonlinear optical process in the fiber-optic link and (ii) a set of other constellation symbols from the first sequence;
generating a perturbed constellation symbol by altering the selected constellation symbol using the first respective perturbation amount; and
driving an optical modulator using one or more electrical drive signals generated based on the perturbed constellation symbol.
